(19) United States
(12) Patent Application Publication
(10) Pub. No.: US 2026/0156628 A1
(43) Pub. Date: Jun. 4, 2026

(54) WIRELESS COMMUNICATION METHOD, TERMINAL DEVICE, AND COMMUNICATION DEVICE

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/378,736

(22) Filed: Nov. 4, 2025

Related U.S. Application Data
(63) Continuation of application No. PCT/CN2023/107753, filed on Jul. 17, 2023.

(51) Int. Cl. H04W 72/0453; H04W 72/0446; H04W 72/51; H04W 72/563

(52) U.S. Cl. CPC H04W 72/0453; H04W 72/0446; H04W 72/51; H04W 72/563

(57) ABSTRACT

A terminal device, including: a communication unit, configured to transmit or receive a signal through a plurality of carriers, where time domain units corresponding to a portion or all of the plurality of carriers have different durations, and the time domain units corresponding to the portion or all of the plurality of carriers overlap in time domain. The time domain units corresponding to the plurality of carriers include a target time period, and the target time period is used for adjusting target power of the signal.

### CROSS-REFERENCE TO RELATED APPLICATION

This application is a Continuation Application of International Application No. PCT/CN2023/107753 filed on Jul. 17, 2023, which is incorporated herein by reference in its entirety.

### TECHNICAL FIELD

Embodiments of the present application relate to the field of communication technology, and in particular, to a wireless communication method, a terminal device and a communication device.

### BACKGROUND

Currently, in order to increase communication transmission rates, signals can be transmitted between communication devices using multiple carriers. In some scenarios, if the durations of time domain units corresponding to multiple carriers differ, the power limitation within those time domain units corresponding to the multiple carriers may change. The conventional power adjustment mechanism stipulates that a terminal device can set the transmit power and/or receive power on multiple carriers based on the total transmit power limitation at an initial phase of a time domain unit, and maintain the transmit power and/or receive power unchanged throughout that time domain unit. Therefore, if the durations of time domain units corresponding to multiple carriers differ, adhering to the conventional power adjustment mechanism for power control may result in degraded signal transmission performance.

### SUMMARY

The present application provides a wireless communication method, a terminal device, a communication device, an apparatus, a chip, a non-transitory computer-readable storage medium, a computer program product, and a computer program. The various aspects of the present application will be introduced below.

In a first aspect, a wireless communication method is provided, which includes: transmitting or receiving, by a terminal device, a signal through a plurality of carriers; where time domain units corresponding to a portion or all of the plurality of carriers have different durations, and the time domain units corresponding to the portion or all of the plurality of carriers overlap in time domain; where time domain units corresponding to the plurality of carriers include a target time period, and the target time period is used for adjusting target power of the signal.

According to a second aspect, a wireless communication method is provided, which includes: receiving or transmitting, by a target device, a signal through a plurality of carriers; where time domain units corresponding to a portion or all of the plurality of carriers have different durations, and the time domain units corresponding to the portion or all of the plurality of carriers overlap in time domain; where time domain units corresponding to the plurality of carriers include a target time period, and the target time period is used for adjusting target power of the signal.

According to a third aspect, a terminal device is provided, which includes: a communication unit, configured to transmit or receive a signal through a plurality of carriers; where time domain units corresponding to a portion or all of the plurality of carriers have different durations, and the time domain units corresponding to the portion or all of the plurality of carriers overlap in time domain; where time domain units corresponding to the plurality of carriers include a target time period, and the target time period is used for adjusting target power of the signal.

In a fourth aspect, a communication device is provided, which includes: a communication unit, configured to receive or transmit a signal through a plurality of carriers; where time domain units corresponding to a portion or all of the plurality of carriers have different durations, and the time domain units corresponding to the portion or all of the plurality of carriers overlap in time domain; where time domain units corresponding to the plurality of carriers include a target time period, and the target time period is used for adjusting target power of the signal.

In a fifth aspect, a terminal device is provided, which includes a processor, a memory, and a communication interface. The memory is configured to store one or more computer programs, and the processor is configured to invoke the computer program(s) in the memory to cause the terminal device to execute part or all of the steps in the method in the first aspect.

In the sixth aspect, a communication device is provided, which includes a processor, a memory, and a transceiver. The memory is configured to store one or more computer programs, and the processor is configured to invoke the computer program(s) in the memory to cause the communication device to execute part or all of the steps in the method in the second aspect.

In some implementations, the above-mentioned communication device may be a network device or another terminal device other than the terminal device in the first aspect.

In a seventh aspect, the embodiments of the present application provide a communication system, which includes the above-mentioned terminal device and/or network device. In another possible design, the system may further include other devices defined in the solutions provided by the embodiments of the present application, which interact with the terminal device or network device.

In an eighth aspect, the embodiments of the present application provide a non-transitory computer-readable storage medium having a computer program stored thereon. The computer program causes a communication device (e.g., a terminal device or a network device) to perform part or all of the steps in the methods in the above aspects.

In a ninth aspect, the embodiments of the present application provide a computer program product. The computer program product includes a non-transitory computer-readable storage medium having a computer program stored thereon, which is executable to cause a communication device (e.g., a terminal device or a network device) to perform part or all of the steps in the methods in the above aspects. In some implementations, the computer program product may be a software installation package.

In a tenth aspect, the embodiments of the present application provide a chip, which includes a memory and a processor. The processor can invoke and execute a computer program from the memory to implement part or all of the steps described in the methods in the above aspects.

### BRIEF DESCRIPTION OF THE DRAWINGS

FIG. 1 illustrates a wireless communication system 100 applied to the embodiments of the present application.

FIG. 2 is a schematic diagram illustrating intra-band multi-carrier transmission to which the embodiments of the present application is applicable.

FIG. 3 is a schematic diagram illustrating durations of time domain units corresponding to different carriers in a case where sub-carrier spacings of multiple intra-band carriers are the same.

FIG. 4 is a schematic diagram illustrating durations of time domain units corresponding to different carriers in a case where sub-carrier spacings of multiple intra-band carriers are different.

FIG. 5 is a schematic diagram illustrating variation of the transmit power limitation on time domain units corresponding to different carriers in the scenario shown in FIG. 4.

FIG. 6 is another schematic diagram illustrating variation of the transmit power limitation on time domain units corresponding to different carriers in the scenario shown in FIG. 4.

FIG. 7 is a schematic diagram illustrating variation of the receive power limitation on time domain units corresponding to different carriers in the scenario shown in FIG. 4.

FIG. 8 is another schematic diagram illustrating variation of the receive power limitation on time domain units corresponding to different carriers in the scenario shown in FIG. 4.

FIG. 9 is a schematic flowchart of a wireless communication method in an embodiment of the present application.

FIG. 10 is another schematic diagram illustrating durations of time domain units corresponding to different carriers in a case where sub-carrier spacings of multiple intra-band carriers are different.

FIG. 11 is a schematic diagram illustrating a time domain location of a target time period in an embodiment of the present application.

FIG. 12 is a schematic diagram illustrating a time domain location of a target time period in another embodiment of the present application.

FIG. 13 is a schematic diagram illustrating a time domain location of a target time period in yet another embodiment of the present application.

FIG. 14 is a schematic diagram illustrating transmit power scheduling in an embodiment of the present application.

FIG. 15 is a schematic diagram illustrating sidelink signal transmission between multiple terminal devices.

FIG. 16 is a schematic diagram illustrating variation of the receive power limitation in an embodiment of the present application.

FIG. 17 is a schematic flowchart of a method for adjusting transmit power in an embodiment of the present application.

FIG. 18 is a schematic diagram of a terminal device in an embodiment of the present application.

FIG. 19 is a schematic diagram of a communication device in an embodiment of the present application.

FIG. 20 is a schematic structural diagram of a communication device in an embodiment of the present application.

### DETAILED DESCRIPTION

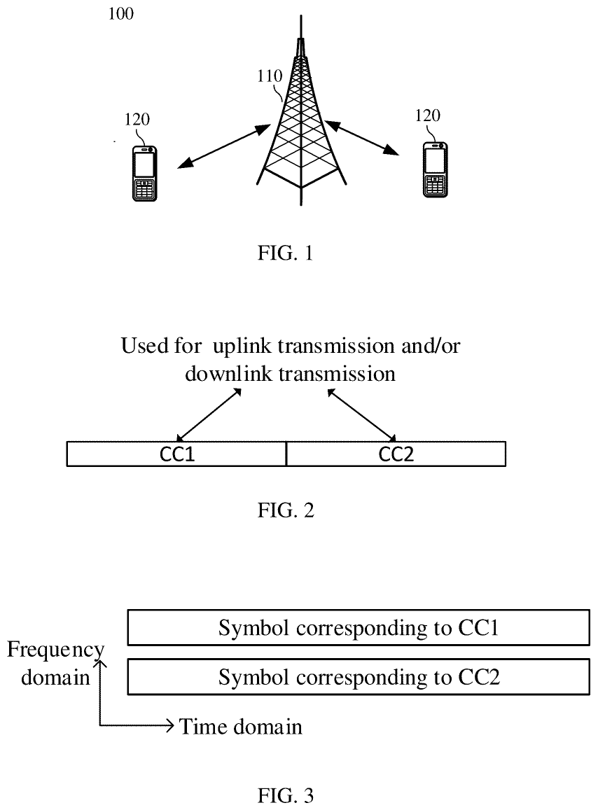

The technical solutions in the present application will be described below with reference to the accompanying drawings. To facilitate understanding, the terms and communication procedures involved in the embodiments of the present application will be described below with reference to FIGS. 1 to 8.

FIG. 1 illustrates a wireless communication system 100 applied to the embodiments of the present application. The wireless communication system 100 may include a network device 110 and terminal device(s) 120. The network device 110 may be a device that communicates with the terminal device(s) 120. The network device 110 may provide communication coverage for a specific geographical area and may communicate with the terminal device(s) 120 located within the coverage area.

In some implementations, a terminal device 120 may also communicate with other terminal devices 120. The communication between this terminal device 120 and the other terminal devices 120 may also be referred to as sidelink communication. Accordingly, the communication link between the terminal device 120 and the other terminal devices 120 may be referred to as a sidelink.

FIG. 1 exemplarily shows one network device and two terminals. Optionally, the wireless communication system 100 may include a plurality of network devices, each of which may have a coverage area in which other number of terminal devices are included, which is not limited in the embodiments of the present application.

Optionally, the wireless communication system 100 may further include other network entities such as a network controller, and a mobility management entity, which are not limited in the embodiment of the present application.

It should be understood that the technical solutions in the embodiments of the present application are applicable to various communication systems, such as: a fifth generation (5G) system or new radio (NR) system, a long term evolution (LTE) system, a LTE frequency division duplex (FDD) system, and a LTE time division duplex (TDD) system. The technical solutions provided in the present application are also applicable to future communication systems, such as a sixth-generation mobile communication system, and a satellite communication system.

The terminal device in the embodiments of the present application may also be referred to as a user equipment (UE), an access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The terminal device in the embodiments of the present application may refer to a device that provides voice and/or data connectivity to a user and may be used to connect people, objects, and machines, such as a handheld device or vehicle-mounted device with a wireless connection function. The terminal device in the embodiments of the present application may be a mobile phone, a pad, a laptop computer, a personal digital assistant, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, etc. Optionally, the UE may act as a base station. For example, the UE may act as a scheduling entity that provides sidelink signals between UEs in V2X or D2D. For example, a cellular phone and a vehicle communicate with each other using sidelink signals. A cellular phone and a smart home device communicate with each other directly, i.e., without relaying communication signals through a base station.

The network device in the embodiments of the present application may be a device used to communicate with a terminal device, and the network device may also be referred to as an access network device or a wireless access network device. For example, the network device may be a base station. The network device in the embodiments of the present application may refer to a radio access network (RAN) node (or device) that connects terminal devices to a wireless network. The term “base station” can broadly cover or be replaced by various names such as: NodeB, evolved NodeB (eNB), next generation NodeB (gNB), relay station, access point, transmitting and receiving point (TRP), transmitting point (TP), master eNB (MeNB), secondary eNB (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), or positioning node. The base station may be a macro base station, a micro base station, a relay node, a donor node or analogues, or a combination thereof. The base station may also refer to a communication module, modem, or chip installed within the aforementioned devices or apparatuses. The base station may also be a mobile switching center, a device that assumes base station functionality in device-to-device (D2D) communication, vehicle-to-everything (V2X) communication, and machine-to-machine (M2M) communications, a network-side device in a 6G system, or a device assuming base station functionality in future communication systems. The base station can support networks that use the same or different access technologies. The embodiments of the present application do not limit the specific technology and specific device form adopted by the network device.

The base station may be fixed or mobile. For example, a helicopter or drone can be configured to act as a mobile base station, and one or more cells can move based on the location of the mobile base station. In other examples, a helicopter or drone may be configured to function as a device communicating with another base station.

In some deployments, the network device in the embodiments of the present application may refer to a CU or a DU, or the network device includes both a CU and a DU. A gNB may also include an AAU.

The network device and the terminal device can be deployed on land, including indoors or outdoors, handheld or vehicle-mounted; they can also be deployed on the water surfaces; and they can also be deployed in the air on aircraft, balloons and satellites. The embodiments of the present application do not limit the scenarios in which the network device and terminal device are located.

It should be understood that all or part of the functions of communication devices in the present application may also be implemented through software functions running on hardware, or through virtualization functions instantiated on a platform (such as a cloud platform).

### Carrier Aggregation Technology

In order to meet the requirements for increasing single-user peak rates and system capacity, one of the most direct ways is to expand the system transmission bandwidth. Consequently, a technology for expanding transmission bandwidth, namely, carrier aggregation (CA) technology, is introduced into communication systems. Whit CA technology, multiple (e.g., 2 to 5) component carriers (CCs) can be aggregated together to increase transmission bandwidth, effectively improving both uplink and downlink transmission rates.

In some implementations, the CCs participating in the aggregation may be carriers adjacent or not adjacent in frequency band. In other implementations, CA technology can be categorized according to the range of aggregated carriers. The types of CA may include intra-band CA and inter-band CA. As the name suggests, for intra-band CA, CCs participating in carrier aggregation belong to the same frequency band. For inter-band CA, CCs participating in carrier aggregation belong to multiple different frequency bands. Intra-band multi-carrier transmission is described below with reference to FIG. 2.

### Multi-Carrier Transmission

As mentioned earlier, multi-carrier is an important means for terminal devices or network devices to improve communication transmission rates. For example, in carrier aggregation (CA) or dual connectivity (DC), the network device can configure multiple CCs for a terminal device to expand transmission bandwidth and thereby improve the transmission rate. As shown in FIG. 2, the network device configures CC1 and CC2 for the terminal device based on the frequency band combination capability supported by the terminal device, where both CC1 and CC2 are located within the same frequency band. Accordingly, the terminal device can perform uplink transmission and/or downlink transmission according to CC1 and CC2 configured by the network device.

This scheme of signal transmission based on multiple CCs within the same frequency band is referred to as intra-band multi-carrier transmission. The multiple CCs used in the intra-band multi-carrier transmission may include multiple intra-band contiguous CCs, or multiple intra-band non-contiguous CCs, or part of intra-band contiguous CCs and part of intra-band non-contiguous CCs. The embodiments of the present application do not impose limitations on this aspect.

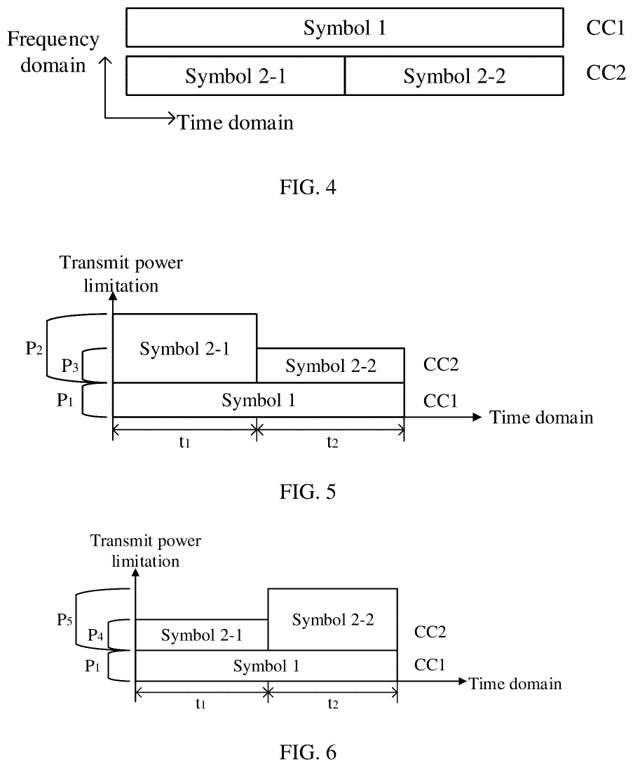

In addition, the sub-carrier spacings (SCSs) of the multiple CCs involved in the intra-band multi-carrier transmission may be the same. Certainly, the SCSs of the multiple carriers may be different. FIG. 3 and FIG. 4 illustrate the durations of the time domain units in cases where the sub-carrier spacings of the multiple intra-band CCs are the same and different, respectively. A time domain unit herein may be a time domain unit of time domain resources in the time domain. For example, the time domain unit may be a time slot, a symbol (also referred to as a “time domain symbol”), a subframe, etc. Correspondingly, taking a symbol as an example of a time domain unit, the duration of the time domain unit may be the symbol duration. To facilitate understanding, the symbol is used as an example of the time domain unit in the following description.

As shown in FIG. 3, the multiple intra-band CCs include CC1 and CC2. In this case, if the sub-carrier spacings of CC1 and CC2 are the same, symbol durations of the symbols corresponding to CC1 and CC2 are the same.

As shown in FIG. 4, the multiple intra-band CCs include CC1 and CC2. In this case, if the sub-carrier spacings of CC1 and CC2 are different, symbol durations of the symbols corresponding to CC1 and CC2 are different. For example, the symbol duration of Symbol 1 corresponding to CC1 is twice the symbol duration of Symbol 2 corresponding to CC2, that is, the symbol duration of Symbol 1 corresponding to CC1 is the sum of the symbol durations of Symbol 2-1 and Symbol 2-2 corresponding to CC2.

### Transmit Power Control for Intra-Band Multi-Carrier Transmission

For intra-band multi-carrier transmission, the terminal device uses the same power amplifier (PA) for power amplification. If the multiple CCs have the same SCS and the time domain start positions of the time domain units corresponding to the multiple CCs are the same, then throughout the entire transmission period of a time domain unit, the transmit power for the terminal device (or in other words, the transmit power limitation) to transmit signals on each CC remains identical, and consequently, the total power for transmitting signals on multiple CCs also remains constant. In this case, the terminal device can use the same PA to amplify the power of the signals transmitted on multiple carriers. Here, the transmit power limitation is used to constrain the transmit power of signals, or in other words, control the transmit power of signals. Typically, the actual transmit power of the signal is less than or equal to the transmit power limitation.

If the multiple CCs employ different SCSs, even if the time domain start positions of the time domain units corresponding to the multiple CCs are the same, during the entire transmission period of a time domain unit (e.g., the time domain unit with the longest duration among the time domain units corresponding to the multiple CCs), the total transmit power limitation for the terminal device to transmit signals on the multiple CCs needs to take into account the respective transmit power limitation for the multiple carriers in signal transmission in different time domain units. To facilitate understanding, the following explanation uses the durations of time domain units corresponding to multiple carriers shown in FIG. 4 as an example, with reference to FIGS. 5 and 6.

Based on the introduction to FIG. 4, the time domain start position of Symbol 1 is the same as the time domain start position of Symbol 2. Since the symbol duration of Symbol 1 corresponding to CC1 equals to the sum of the symbol durations of Symbol 2-1 and Symbol 2-2 corresponding to CC2, the total transmit power limitation for the terminal device to transmit signals during the time period corresponding to Symbol 1 needs to consider the transmit power limitation for transmitting signals on Symbol 2-1 and the transmit power limitation for transmitting signals on Symbol 2-2.

As shown in FIG. 5, under the assumption that the transmit power limitation for transmitting signals on Symbol 1 is P₁ and the transmit power limitation P₂ for transmitting signals on Symbol 2-1 is greater than the transmit power limitation P₃ for transmitting signals on Symbol 2-2, the transmit power limitation for the terminal device to transmit signals within time period t₁ corresponding to Symbol 2-1 is Pₜ₁=P₁+P₂, and the transmit power limitation for the terminal device to transmit signals within time period t₂ corresponding to Symbol 2-2 is Pₜ₂=P₁+P₃. That is to say, within time period t corresponding to Symbol 1, the total transmit power limitation for the terminal device to transmit signals decreases.

As shown in FIG. 6, under the assumption that the transmit power limitation for transmitting signals on Symbol 1 is P₁ and the transmit power limitation P₄ for transmitting signals on Symbol 2-1 is less than the transmit power limitation P₅ for transmitting signals on Symbol 2-2, the transmit power limitation for the terminal device to transmit signals within time period t₁ corresponding to Symbol 2-1 is Pₜ₁=P₁+P₄, and the transmit power limitation for the terminal device to transmit signals within time period t₂ corresponding to Symbol 2-2 is Pₜ₂=P₁+P₅. That is to say, within time period t corresponding to Symbol 1, the total transmit power limitation for the terminal device to transmit signals increases.

It should be noted that, in the embodiments of the present application, part of the multiple time domain units corresponding to the second carrier may not be used for signal transmission. In this case, the transmit power limitation may also change. For example, referring again to FIG. 5, it is assumed that Symbol 2-1 is not used for signal transmission, but Symbol 2-2 is used for signal transmission, in this case, during the time period corresponding to Symbol 1, the transmit power limitation will also change. As another example, referring again to FIG. 5, it is assumed that Symbol 2-2 is not used for signal transmission, but Symbol 2-1 is used for signal transmission, in this case, during the time period corresponding to Symbol 1, the transmit power limitation will also change. For example, referring again to FIG. 6, it is assumed that Symbol 2-1 is not used for signal transmission, but Symbol 2-2 is used for signal transmission, in this case, during the time period corresponding to Symbol 1, the transmit power limitation will also change. As another example, referring again to FIG. 6, it is assumed that Symbol 2-2 is not used for signal transmission, but Symbol 2-1 is used for signal transmission, in this case, during the time period corresponding to Symbol 1, the transmit power limitation will also change.

### Receive Power Adjustment for Intra-Band Multi-Carrier Transmission in Sidelink Communication Scenario

In the sidelink communication scenario, in addition to the situations where the total transmit power limitation may change as described above with reference to FIGS. 5 and 6, there may also be scenarios where the receive power limitation undergoes changes. The receive power limitation is used to constrain the receive power of signals, or in other words, control the receive power of signals, for example, control the receive power of signals to be less than or equal to the receive power limitation.

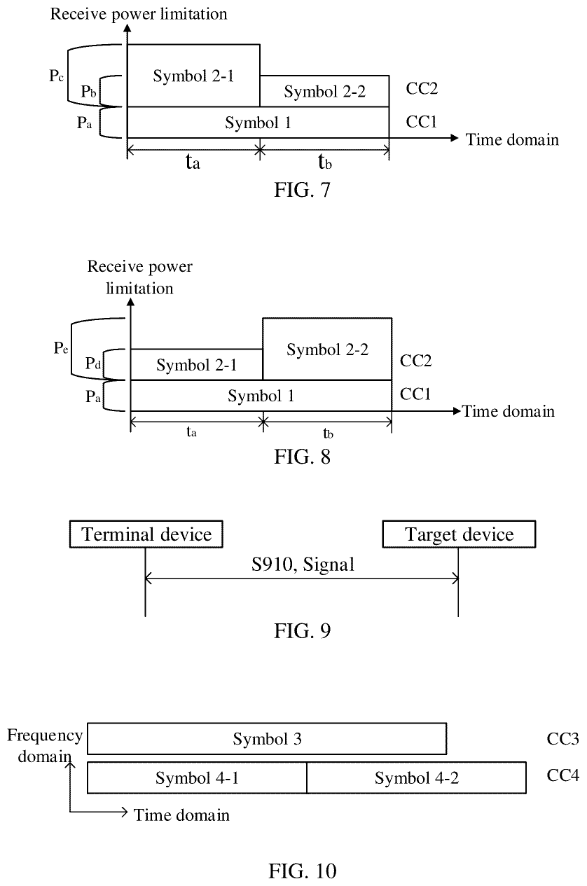

If the multiple CCs employ different SCSs, even if the time domain start positions of the time domain units corresponding to the multiple CCs are the same, during the entire transmission of a time domain unit (for example, the time domain unit with the longest duration among the time domain units corresponding to the multiple CCs), the total power limitation for the terminal device to transmit signals on the multiple CCs needs to take into account the respective receive power limitation for the multiple carriers in signal transmission in different time domain units. To facilitate understanding, the following explanation uses the durations of time domain units corresponding to multiple carriers shown in FIG. 4 as an example, with reference to FIGS. 7 and 8.

Based on the introduction to FIG. 4, the time domain start position of Symbol 1 is the same as the time domain start position of Symbol 2. Since the symbol duration of Symbol 1 corresponding to CC1 is the sum of the symbol durations of Symbol 2-1 and Symbol 2-2 corresponding to CC2, the total receive power limitation for the terminal device to receive signals during the time period corresponding to Symbol 1 needs to consider the receive power limitation for receiving signals on Symbol 2-1 and the receive power limitation for receiving signals on Symbol 2-2.

As shown in FIG. 7, under the assumption that the receive power limitation for receiving signals on Symbol 1 is Pₐ and the receive power limitation P_{c} for receiving signals on Symbol 2-1 is greater than the receive power limitation P_{b} for receiving signals on Symbol 2-2, the receive power limitation for the terminal device to receive signals within time period t₁ corresponding to Symbol 2-1 is Pₜₐ=Pₐ+P_{b}, and the receive power limitation for the terminal device to receive signals within time period t_{b} corresponding to Symbol 2-2 is P_{tb}=Pₐ+P_{c}. That is to say, within time period t corresponding to Symbol 1, the total receive power limitation for the terminal device to receive signals decreases.

As shown in FIG. 8, under the assumption that the receive power limitation for receiving signals on Symbol 1 is Pₐ and the receive power limitation Pₐ for receiving signals on Symbol 2-1 is less than the receive power limitation Pe for receiving signals on Symbol 2-2, the receive power limitation for the terminal device to receive signals within time period ta corresponding to Symbol 2-1 is Pₐ+Pₐ, and the receive power limitation for the terminal device to receive signals within time period t₂ corresponding to Symbol 2-2 is P_{tb}=Pₐ+Pₑ. That is to say, within time period t corresponding to Symbol 1, the total receive power limitation for the terminal device to receive signals increases.

It should be noted that, in the embodiments of the present application, part of the multiple time domain units corresponding to the second carrier may not be used for signal reception. In this case, the receive power limitation may also change. For example, referring again to FIG. 7, it is assumed that Symbol 2-1 is not used for signal reception, but Symbol 2-2 is used for the signal reception, in this case, during the time period corresponding to Symbol 1, the receive power limitation will also change. As another example, referring again to FIG. 7, it is assumed that Symbol 2-2 is not used for signal reception, but Symbol 2-1 is used for signal reception, in this case, during the time period corresponding to Symbol 1, the receive power limitation will also change. For example, referring again to FIG. 8, it is assumed that Symbol 2-1 is not used for signal reception, but Symbol 2-2 is used for signal reception, in this case, during the time period corresponding to Symbol 1, the receive power limitation will also change. As another example, referring again to FIG. 8, it is assumed that Symbol 2-2 is not used for the signal reception, but Symbol 2-1 is used for signal reception, in this case, during the time period corresponding to Symbol 1, the receive power limitation will also change.

As introduced above with reference to FIGS. 4 to 8, if the sub-carrier spacings of the multiple CCs are different, or in other words, the durations of the time domain units corresponding to CCs with different sub-carrier spacings differ, a situation may occur where a time domain unit corresponding to one CC overlaps in the time domain with the time domain units corresponding to multiple other CCs. In such a case, within that time domain unit corresponding to the one CC (e.g., the time domain unit with the longest duration among the time domain units corresponding to the multiple CCs), the total transmit power limitation/the total receive power limitation for transmitting/receiving signals may change, and this change may affect the signal transmission performance.

In one aspect, conventional transmit power adjustment mechanism stipulates that a terminal device can set the transmit power on multiple CCs based on the total transmit power limitation at an initial phase of a time domain unit, and maintain the transmit power throughout that time domain unit. According to this transmit power adjustment mechanism, within the time domain units corresponding to multiple CCs, the terminal device can set the transmit power only at an initial phase of a time domain unit, and employ the set transmit power for signal transmission throughout all time domain units corresponding to the multiple CCs. That is to say, the transmit power in the time domain units corresponding to the multiple CCs is a fixed value. Such a fixed transmit power approach cannot adapt to the varying total transmit power limitation shown in FIGS. 5 and 6, resulting in degraded signal transmission performance.

As shown in FIG. 5, according to the total transmit power limitation in time domain unit 1 and time domain unit 2-1, the terminal device may set the transmit power on CC1 and CC2 at a time domain start position of a time domain unit. Afterwards, although the transmit power limitation on CC2 decreases within time domain unit 2-1, causing the total transmit power limitation corresponding to CC1 and CC2 to decrease, the terminal device cannot further reduce the transmit power. In such a case, within time domain unit 2-2, the PA of the terminal device still amplifies the transmit power with the amplification gain used within time domain unit 2-1. Ultimately, this mechanism will result in the transmit power within time domain unit 2-2 exceeding the transmit power limitation corresponding to time domain unit 2-1, thereby leading to signal clipping and/or degraded signal linearity, which reduces signal quality.

As shown in FIG. 6, according to the total transmit power limitation in the time domain unit 1 and time domain unit 2-1, the terminal device may set the transmit power on CC1 and CC2 at a time domain start position of a time domain unit. Afterwards, although the transmit power limitation on CC2 decreases within time domain unit 2-1, causing the total transmit power limitation corresponding to CC1 and CC2 to increase, the terminal device cannot further increase the transmit power for signals transmitted on Symbol 2-2. In such a case, within time domain unit 2-1, the PA of the terminal device still amplifies the transmit power with the amplification gain used in time domain unit 2-2. Ultimately, this mechanism will result in lower transmit power within time domain unit 2-2, reducing the signal-to-noise ratio of signals at the receiver, thereby decreasing the success rate of signal demodulation and/or decoding at the receiver.

In another aspect, for a receiving terminal, before receiving sidelink information, the receiving terminal needs to measure the strength of the received signal and adjust the amplification gain of its receiver (that is, perform automatic gain control (AGC)) to keep the demodulated signal remaining at a relatively constant value for sampling and digital quantization processing by the analog-to-digital conversion (ADC) module. The conventional receive power adjustment mechanism stipulates that the AGC process of the terminal device needs to be completed before the terminal device receives the sidelink signal (i.e., the useful signal) and remains unchanged during the reception of the useful signal symbol. According to this receive power adjustment mechanism, within time domain units corresponding to multiple CCs, the terminal device can set the receive power only at the initial phase of a time domain unit, and use this set receive power to receive signals throughout the time domain units corresponding to multiple CCs. This receive power setting method can be understood as using a fixed receive power throughout the time domain units corresponding to multiple CCs. Such a fixed receive power approach cannot adapt to the varying total receive power limitation shown in FIGS. 7 and 8, resulting in degraded signal transmission performance.

As shown in FIG. 7, according to the total receive power limitation in the time domain unit 1 and time domain unit 2-1, the terminal device may set the receive power on CC1 and CC2 at a time domain start position of a time domain unit. Afterwards, although the receive power limitation on CC2 decreases within time domain unit 2-1, causing the total receive power limitation corresponding to both CC1 and CC2 to decrease, the receiving terminal cannot further reduce the receive power. In such a case, within time domain unit 2-2, the PA of the receiving terminal still employs the AGC determined within time domain unit 2-1. Ultimately, this mechanism will result in a relatively high receive power within time domain unit 2-2, or in other words, lead to an excessively high amplification gain applied to signals received within time domain unit 2-2, which may result in a degraded output signal-to-noise ratio from the ADC after sampling and conversion, thereby decreasing the success rate of signal demodulation and/or decoding at the receiver.

As shown in FIG. 8, according to the total receive power limitation in the time domain unit 1 and time domain unit 2-1, the terminal device may set the receive power on CC1 and CC at a time domain start position of a time domain unit. Afterwards, although the receive power limitation on CC2 increases within time domain unit 2-1, causing the total receive power limitation corresponding to CC1 and CC2 to increase, the receiving terminal cannot further increase the receive power. In such a case, within time domain unit 2-1, the PA of the receiving terminal still employs the AGC determined within time domain unit 2-2. Ultimately, this mechanism will result in a lower receive power within time domain unit 2-2, or in other words, lead to an excessively lower amplification gain applied to signals received within time domain unit 2-2, which may result in a degraded output signal-to-noise ratio from the ADC after sampling and conversion, thereby decreasing the success rate of signal demodulation and/or decoding at the receiver.

Therefore, to address the aforementioned problems, the embodiments of the present application provide a wireless communication method. In this method, a target time period can be configured within the time domain units corresponding to multiple CCs, and the target time period can be used for adjusting the target power of signals, thereby improving the target power of signals transmitted within the time domain units corresponding to the multiple CCs, which contributes to enhanced signal transmission performance. To facilitate understanding, the wireless communication method provided in the embodiments of the present application will be introduced below with reference to FIG. 9. The wireless communication method shown in FIG. 9 includes step S910.

In step S910, a terminal device transmits or receives a signal through a plurality of CCs. The signal may be a signal transmitted between the terminal device and a network device (as an example of a target device), such as a signal received by the terminal device from the network device through the plurality of CCs, or a signal transmitted by the network device to the terminal device through the plurality of CCs. Certainly, in the embodiments of the present application, the above-mentioned signal may also be a signal transmitted between one terminal device and another terminal device (as an example of a target device), such as a signal transmitted by the one terminal device to another terminal through the plurality of CCs, or a signal transmitted by other terminals to the one terminal device through the plurality of CCs.

In some implementations, time domain units corresponding to a portion or all of the plurality of CCs have different durations, or in other words, the sub-carrier spacings of a portion or all of the plurality of CCs differ.

In some implementations, the time domain units corresponding to the portion or all of the plurality of carriers overlap in the time domain. For example, the plurality of carriers includes a first carrier and a second carrier, the first carrier corresponds to a first time domain unit, and the second carrier corresponds to second time domain units. Part or all of the duration of a first time domain unit is overlapped by the durations of a plurality of second time domain units, and the duration of the first time domain unit is greater than the duration of the second time domain unit.

The entire duration of the first time domain unit is overlapped by the durations of the plurality of second time domain units, which may be understood as that the duration of the first time domain unit encompasses the durations of the plurality of second time domain units. Referring again to FIG. 4, the first carrier may, for example, be CC1, and the second carrier may, for example, be CC2. CC1 corresponds to Symbol 1, and CC2 corresponds to Symbols 2. Accordingly, Symbol 1 overlaps with the multiple Symbols 2 (i.e., Symbol 2-1 and Symbol 2-2) in the time domain, that is to say, the duration corresponding to Symbol 1 encompasses the durations of two Symbols 2.

A portion of the duration of the first time domain unit is overlapped by the durations of the plurality of second time domain units, which may be understood as that the duration of the first time domain unit includes a portion of durations of the plurality of second time domain units. As shown in FIG. 10, the first carrier may, for example, be CC3, and the second carrier may, for example, be CC4. CC3 corresponds to Symbol 3, and CC4 corresponds to Symbols 4. Accordingly, Symbol 3 overlaps with the multiple Symbols 4 in the time domain, that is to say, the duration corresponding to Symbol 3 includes the duration of the first Symbol 4 (i.e., Symbol 4-1) and a portion of the duration of the second Symbol 4 (i.e., Symbol 4-2).

It should be noted that the start position of the first time domain unit in the time domain is the same as that of the second time domain unit in the time domain, or the start position of the first time domain unit in the time domain is different from that of the second time domain unit in the time domain, which is not limited in the embodiments of the present application.

In addition, in the foregoing description of the time domain locations of the time domain unit corresponding to the first carrier and the time domain units corresponding to the second carrier, the number of time domain units corresponding to the second carrier was described by way of example as two, which, however, is not limited in the embodiments of the present application. The number of time domain units corresponding to the second carrier may also be other quantities. For example, in the time domain, the time domain unit corresponding to the first carrier may be overlapped by three time domain units corresponding to the second carrier.

In some implementations, the time domain units corresponding to the plurality of carriers include a target time period, and the target time period is used for adjusting the target power of signals. The target power may include transmit power and/or receive power. In the embodiments of the present application, the target time period may be expressed in the form of a time window, and therefore, the target time period may also be referred to as a “power adjust period”.

The time domain location of the target time period in the embodiments of the present application will be described in the following. In some implementations, the time domain location of the target time period may be determined based on an adjacent time domain boundary position between two second time domain units in the plurality of second time domain units, or in other words, the time domain location of the target time period is configured such that the target time period includes the time corresponding to the adjacent time domain boundary position between the two second time domain units. For ease of description, the two second time domain units adjacent in the time domain are hereafter referred to as “third time domain unit” and “fourth time domain unit” hereinafter, and the third time domain unit is earlier than the fourth time domain unit in time domain.

Correspondingly, the time domain boundary position between the adjacent third time domain unit and fourth time domain unit may be referred to as a “first time domain position”. In some implementations, the first time domain position may be determined based on the time domain end position of the third time domain unit and/or the time domain start position of the fourth time domain unit. For example, the first time domain position may be the time domain end position of the third time domain unit. In another example, the first time domain position may be determined based on the time domain end position and a time domain offset value of the third time domain unit. In another example, the first time domain position may be the time domain start position of the fourth time domain unit. In another example, the first time domain position may be determined based on the time domain start position of the fourth time domain unit and a time domain offset value. The time domain offset value herein may be predefined, preconfigured, or configured by the network device.

In the embodiments of the present application, the time domain location of the target time period is not limited. The time domain location of the target time period may be the time domain start position, time domain end position, or time domain center position of the target time period. Certainly, the time domain location of the target time period may also be any time domain location of the target time period.

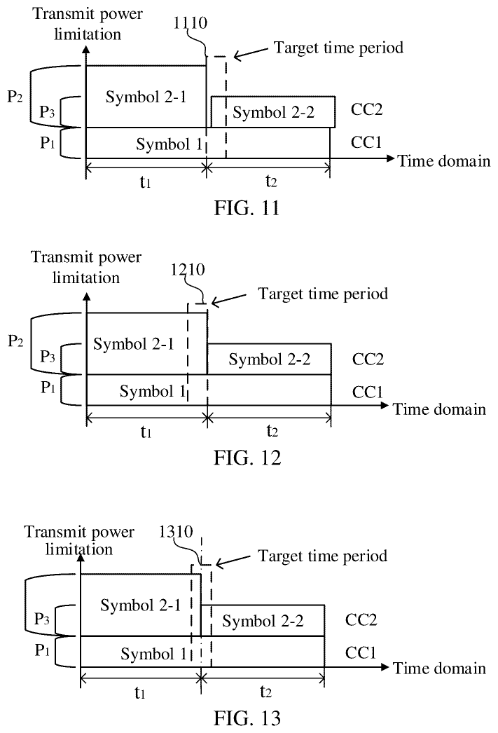

To facilitate understanding, the following takes the transmit power limitation variation manner shown in FIG. 5 as an example and introduces the time domain location of the target time period in the embodiments of the present application with reference to FIGS. 11 to 13. It should be noted that the configuration of the target time period in the embodiments of the present application may also be applied to the power limitation variation scenarios shown in FIGS. 6 to 8. For the sake of brevity, these scenarios will not be repeatedly described. In the following description, Symbol 1 is assumed to be the first time domain unit, Symbol 2-1 is assumed to be the third time domain unit, and Symbol 2-2 is assumed to be the fourth time domain unit.

As shown in FIG. 11, in an example where the time domain location of the target time unit is time domain start position 1110, time domain start position 1110 may be the time domain end position of Symbol 2-1. Referring again to FIG. 11, in an example where the time domain location of the target time unit is time domain start position 1110, time domain start position 1110 may be the time domain start position of Symbol 2-2.

As shown in FIG. 12, in an example where the time domain location of the target time unit is time domain end position 1210, time domain end position 1210 may be the time domain end position of Symbol 2-1. Referring again to FIG. 12, in an example where the time domain location of the target time unit is time domain end position 1210, time domain end position 1210 may be the time domain start position of Symbol 2-2.

As shown in FIG. 13, in an example where the time domain location of the target time unit is time domain center position 1310, time domain center position 1310 may be the time domain end position of Symbol 2-1. Referring again to FIG. 13, in an example where the time domain location of the target time unit is time domain center position 1310, time domain center position 1310 may be the time domain start position of Symbol 2-2.

Certainly, in the embodiments of the present application, the time domain location of the target time period may also be determined based on the time domain start position of the third time domain unit. For example, the time domain location of the target time period is a time domain position obtained by applying a time domain offset value 1 to a start position along the time-increasing direction, and the start position may be the time domain start position of the third time domain unit. In another example, the time domain location of the target time period is a time domain position obtained by applying a time domain offset value 2 to a start position along the time-decreasing direction, and the start position may be the time domain end position of the fourth time domain unit. The time domain offset value 1 or time domain offset value 2 may be predefined by a protocol, configured by a network device, or preconfigured.

In the embodiments of the present application, the time domain location of the target time period is determined based on one or more of: predefined information, a preset rule, configuration information, and information indicating a time domain location of the target time period suggested by the terminal device.

In an example where the time domain location of the target time period is determined based on the predefined information, the time domain location of the target time period may be determined based on, for example, the predefined information in a communication protocol.

In some implementations, the predefined information may indicate that the target time period is located within the former one of the two adjacent second time domain units. In other words, the predefined information may indicate that the time domain end position of the target time period is the time domain end position of the former one of the two adjacent second time domain units. Taking the scenario shown in FIG. 4 as an example, the predefined information may indicate that the time domain end position of the target time period is the time domain end position of Symbol 2-1.

In other implementations, the predefined information may indicate that the target time period is located within the latter one of the two adjacent second time domain units. In other words, the predefined information may indicate that the time domain start position of the target time period is the time domain start position of the latter one of the two adjacent second time domain units. Taking the scenario shown in FIG. 4 as an example, the predefined information may indicate that the time domain start position of the target time period is the time domain start position of Symbol 2-2.

In an example where the time domain location of the target time period is determined based on the preset rule, the preset rule is used to indicate the time domain location of the target time period. In addition, in the embodiments of the present application, there is no limitation on the method for obtaining the preset rule. The preset rule may be predefined, preconfigured, or indicated by the network device.

In some implementations, the preset rule may be associated with the priority of services transmitted in the second time domain units. For example, the preset rule is used to indicate that the target time period is within time domain unit 1, where time domain unit 1 is a time domain unit among the plurality of second time domain units in which the transmitted services have a lower service priority. In other words, the preset rule is used to indicate that the time domain end position of the target time period is the time domain end position of the time domain unit 1. Certainly, in the embodiments of the present application, the preset rule may also be used to indicate that the time domain end position of the target time period is the time domain end position of time domain unit 2, where the time domain unit 2 is a time domain unit among the plurality of second time domain units in which the transmitted services have a higher service priority.

In some implementations, the preset rule may be associated with the target power (transmit power and/or receive power) of signals transmitted in the second time domain units. For example, the preset rule is used to indicate that the target time period is located within time domain unit 3, where the time domain unit 3 is a time domain unit among the plurality of second time domain units where the transmitted signals have a lower target power. In other words, the preset rule is used to indicate that the time domain end position of the target time period is the time domain end position of the time domain unit 3. Certainly, in the embodiments of the present application, the preset rule may also be used to indicate that the time domain start position of the target time period is the time domain start position of time domain unit 4, where the time domain unit 4 is a time domain unit among the plurality of second time domain units where the transmitted signals have a higher target power.

Certainly, in the embodiments of the present application, there is no specific limitation on the preset rule. For example, the preset rule may also be associated with Quality of Service (QoS) parameters associated with the data. For example, the preset rule is used to indicate that the time domain end position of the target time period is the time domain end position of time domain unit 5, where the time domain unit 5 may be a time domain unit among the plurality of second time domain units that carries data with lower QoS requirements (e.g., longer latency tolerance). Alternatively, the time domain unit 5 may be a time domain unit among the plurality of second time domain units that carries data with higher QoS requirements (e.g., smaller latency tolerance).

In another example, the preset rule introduced above may also be used in combination. Taking the association of a preset rule with both the priority of services transmitted in the second time domain units and the target power of signals transmitted in the second time domain units as an example, the preset rule is used to indicate that the target time period is located within time domain unit 6. The time domain unit 6 is a time domain unit among the plurality of second time domain units in which the transmitted services have a lower service priority and the transmitted signals have a lower target power.

In the case where the time domain location of the target time period is determined based on configuration information, this configuration information is used to configure the time domain location of the target time period for the terminal device. In some implementations, the configuration information may be transmitted by the network device. For example, the configuration information may be carried in one or more of the following: radio resource control (RRC) signaling, medium access control element (MAC CE), and downlink control information (DCI).

As an alternative to determining the time domain location of the target time period based on information indicating the time domain location of the target time period suggested by the terminal device, the time domain location of the target time period is determined based on information of a time domain location of the target time period expected by the terminal device. For example, the terminal device may transmit indication information 1 to the network device to indicate the time domain location of the target time period expected by the terminal device. Correspondingly, the network device may determine the time domain location of the target time period based on the time domain location of the target time period expected by the terminal device. Afterwards, the network device can configure the determined time domain location of the target time period for the terminal device.

It should be noted that determining the time domain location of the target time period based on the time domain location of the target time period expected by the terminal device may include, for example, directly determining the time domain location of the target time period expected by the terminal device as the time domain location of the target time period, or may include making adjustments with the time domain location of the target time period expected by the terminal device as the initial reference, and determining the adjusted time domain location as the time domain location of the target time period.

The time domain location of the target time period in the embodiments of the present application is described in the above, and the method for determining the duration of the target time period in the embodiments of the present application will be described below. It should be understood that, in the embodiments of the present application, there is no limitation on the device for determining the duration of the target time period. For example, the device may be a network device and/or a terminal device.

In some implementations, the duration of the target time period is determined based on one or more of the following: the sub-carrier spacing of the first carrier, the sub-carrier spacing of the second carrier, and a candidate duration of the target time period supported by the terminal device.

In an example where the duration of the target time period is determined based on the sub-carrier spacing of the first carrier, in some implementations, the duration of the target time period associated with the first carrier may be determined based on an association relationship between the sub-carrier spacing and the duration of the target time period. For example, if the association relationship indicates that when the sub-carrier spacing is 15 kilohertz (kHz), the corresponding duration of the target time period is X microseconds (μs). Accordingly, when the sub-carrier spacing of the first carrier is 15 kHz, the duration of the target time period corresponding to the first carrier may be X μs. In another example, if the association relationship indicates that when the sub-carrier spacing is 30 kHz, the duration of the corresponding target time period is Y μs. Accordingly, when the sub-carrier spacing of the first carrier is 30 kHz, the duration of the target time period corresponding to the first carrier may be Y μs.

In an example where the duration of the target time period is determined based on the sub-carrier spacing of the second carrier, in some implementations, the duration of the target time period associated with the second carrier may be determined based on an association relationship between the sub-carrier spacing and the duration of the target time period. For example, if the association relationship indicates that when the sub-carrier spacing is 15 kHz, the duration of the corresponding target time period is X μs. Correspondingly, when the sub-carrier spacing of the second carrier is 15 kHz, the duration of the target time period corresponding to the second carrier may be X μs. In another example, when the association relationship indicates that when the sub-carrier spacing is 30 kHz, the duration of the corresponding target time period is Y μs. Accordingly, when the sub-carrier spacing of the second carrier is 30 kHz, the duration of the target time period corresponding to the second carrier may be Y μs.

Certainly, in the embodiments of the present application, the duration of the target time period may also be determined based on the sub-carrier spacing of the first carrier and the sub-carrier spacing of the second carrier. In some implementations, the duration of the target time period associated with both the second carrier and the first carrier may be determined based on an association relationship between the sub-carrier spacing and the duration of the target time period.

For example, if the association relationship indicates that when the sub-carrier spacings are 15 kHz and 30 kHz, the duration of the corresponding target time period is X μs. Accordingly, when the sub-carrier spacing of the first carrier is 15 kHz and the sub-carrier spacing of the second carrier is 30 kHz, the duration of the target time period corresponding to both the second carrier and the first carrier may be X μs.

In another example, if the association relationship indicates that when the sub-carrier spacings are 15 kHz and 60 kHz, the duration of the corresponding target time period is Y μs. Accordingly, when the sub-carrier spacing of the first carrier is 15 kHz and the sub-carrier spacing of the second carrier is 60 kHz, the duration of the target time period corresponding to both the second carrier and the first carrier may be Y μs.

In an example where the duration of the target time period is determined based on the candidate duration of the target time period supported by the terminal device, in some implementations, the network device may determine the duration of the target time period based on the candidate duration. The candidate duration may be replaced by the duration of the target time period expected by the terminal device. In addition, the candidate duration herein may include one or more durations, which is not limited in the embodiments of the present application.

For example, the candidate durations supported by the terminal device belong to Set A: {A μs, B μs, C μs}. Accordingly, the network device may select one candidate duration from Set A as the duration of the target time period.

In the embodiments of the present application, there is no limitation on the transmission method for the above-mentioned candidate durations. In some implementations, the terminal device may report the candidate durations via terminal capability, that is to say, the candidate durations of the target time period supported by the terminal device may be carried in the terminal device capability information. Certainly, in the embodiments of the present application, the above-mentioned candidate durations may be configured by the network device for the terminal device.

It should be noted that, if the above-mentioned candidate durations are reported via the capability information of the terminal device, the capability information of the terminal device may also be used to indicate that the terminal device supports a first feature, where the first feature includes adjusting the target power within the target time period. That is to say, the candidate durations in the terminal device capability information can indirectly indicate that the terminal device supports the first feature. Certainly, in the embodiments of the present application, the terminal device may use separate signaling to indicate (or directly indicate) that the terminal device supports the first feature. The separate signaling may be other terminal device capability information different from the terminal device capability information carrying the candidate durations.

The methods for determining the duration of the target time period is described in the above, and the methods for configuring and/or activating the target time period in the embodiments of the present application will be described below. In some implementations, the configuration and/or activation of the target time period is determined based on a first condition. The statement “the configuration of the target time period is determined based on the first condition” can be understood as follows: if the first condition is satisfied, the network device configures the target time period for the terminal device. The statement “the activation of the target time period is determined based on the first condition” can be understood as follows: if the first condition is satisfied, the network device activates the configured target time period for the terminal device. That is to say, the network device may first configure one or more available target time periods for the terminal device. Subsequently, if the first condition is satisfied, the network device may transmit an activation indication to the terminal device to indicate to activate one or more available target time periods among the configured available time periods as the target time period.

In some implementations, the first condition includes one or more of the following: signals transmitted in two second time domain units adjacent in the time domain have different target power; the sub-carrier spacing of the first carrier is different from the sub-carrier spacing of the second carrier; or the duration of the first time domain unit is different from the duration of the second time domain unit.

In an example where the first condition includes the signals transmitted in two second time domain units adjacent in the time domain have different target power, when the signals transmitted in the two second time domain units adjacent in the time domain have different target power, the target time period is configured and/or activated; and/or when the transmit power limitations for the signals transmitted in the two second time domain units adjacent in the time domain are different, the target time period is configured and/or activated, or when the receive power limitations for the signals transmitted in the two second time domain units adjacent in the time domain are different, the target time period is configured and/or activated.

Taking the scenario shown in FIG. 4 as an example, if the transmit power limitation on Symbol 2-1 is different from the transmit power limitation on Symbol 2-2, the network device configures a target time period for the terminal device, or the network device activates a configured available target time period for the terminal device.

In an example where the first condition includes that the sub-carrier spacing of the first carrier is different from the sub-carrier spacing of the second carrier, when the sub-carrier spacing of the first carrier is different from the sub-carrier spacing of the second carrier, the target time period is configured and/or activated.

Taking the scenario shown in FIG. 4 as an example, if the sub-carrier spacing of CC1 is different from the sub-carrier spacing of CC2, the network device configures the target time period for the terminal device, or the network device activates a configured available target time period for the terminal device.

In an example where the first condition includes that the duration of the first time domain unit is different from the duration of the second time domain unit, when the duration of the first time domain unit is different from the duration of the second time domain unit, the target time period is configured and/or activated.

Taking the scenario shown in FIG. 4 as an example, if the duration of Symbol 1 is different from the duration of Symbol 2-1, the network device configures the target time period for the terminal device, or the network device activates a configured available target time period for the terminal device.

It should be noted that, the above examples of the first condition can be used individually or in combination. For example, if the first condition includes that the sub-carrier spacing of the first carrier is different from the sub-carrier spacing of the second carrier, and that the transmit power limitations for the signals transmitted in two second time domain units adjacent in the time domain are different, then when the above-mentioned first condition is met, the network device can configure the target time period for the terminal device, or the network device can activate a configured available target time period for the terminal device.

In another example, when the duration of the first time domain unit is different from the duration of the second time domain unit, and the transmit power limitations for the signals transmitted in the two second time domain units adjacent in the time domain are different, the first condition is met, and the network device can configure the target time period for the terminal device, or the network device can activate a configured available target time period for the terminal device.

As described above, the above-mentioned process of determining whether the first condition is satisfied may be executed by the terminal device. In some implementations, if the terminal device determines that the first condition is satisfied, the terminal device may transmit a request to the network device, to request the network device to configure the target time period for the terminal device, or to request the network device to activate the target time period for the terminal device. Certainly, in the embodiments of the present application, the terminal device may not transmit any request to the network device. Instead, both the network device and the terminal device may evaluate whether the first condition is satisfied. If the first condition is satisfied, the network device may actively configure and/or activate the target time period for the terminal device.

As described above, in some scenarios, the network device and/or the terminal device needs to know whether the power limitations (transmit power limitation and/or receive power limitation) for the signals transmitted in two adjacent second carriers in the time domain are different. For example, in a case where the first condition includes that the power limitations (transmit power limitations and/or receive power limitations) for signals transmitted in two second time domain units adjacent in the time domain are different, the network device and/or terminal device needs to know whether the power limitations (transmit power limitations and/or receive power limitations) of signals transmitted in two second time domain units adjacent in the time domain are different. The method for obtaining the variation in power limitation differs depending on whether the power limitation is the transmit power limitation or the receive power limitation. These methods will be described in the following, using Scenario 1 to Scenario 3 as examples.

### Scenario 1: Transmit Power Adjustment Scenario

For transmit power adjustment, the terminal device transmits signals on the first carrier and the second carrier. The transmit power limitation for the terminal device to transmit signals in the time domain units corresponding to the first carrier and the second carrier is scheduled by the network device. In this case, both the network device and the terminal device can determine the transmit power limitation corresponding to each time domain unit based on the transmit power limitation scheduled by the network device. That is to say, if the plurality of carriers are used for transmitting the signal and the target power is the transmit power, then a variation in the transmit power limitation for signals transmitted in the plurality of second time domain units is determined based on the transmit power limitation scheduled by the network device, or in other words, the variation in the transmit power of signals transmitted in the plurality of second time domain units is determined based on the transmit power scheduled by the network device. The network device may schedule the transmit power through, for example, a physical downlink control channel (PDCCH).

FIG. 14 is a schematic diagram of transmit power scheduling in the embodiments of the present application. Referring to FIG. 14, taking the target time period shown in FIG. 11 as an example, the network device transmits a PDCCH to the terminal device to indicate the transmit power limitations associated with Symbol 1 of CC1 and Symbols 2-1 and 2-2 of CC2. Accordingly, based on the indication in the PDCCH, the terminal device can determine that the total transmit power limitation will decrease from P1+P2 to P1+P3 at the transition moment from time period t1 to time period t2. Accordingly, the network device can configure a target time period for the terminal device, enabling the terminal device to adjust the total transmit power limitation from P1+Pd2 to P1+P3 within this target time period.

### Scenario 2: Receive Power Adjustment Scenario

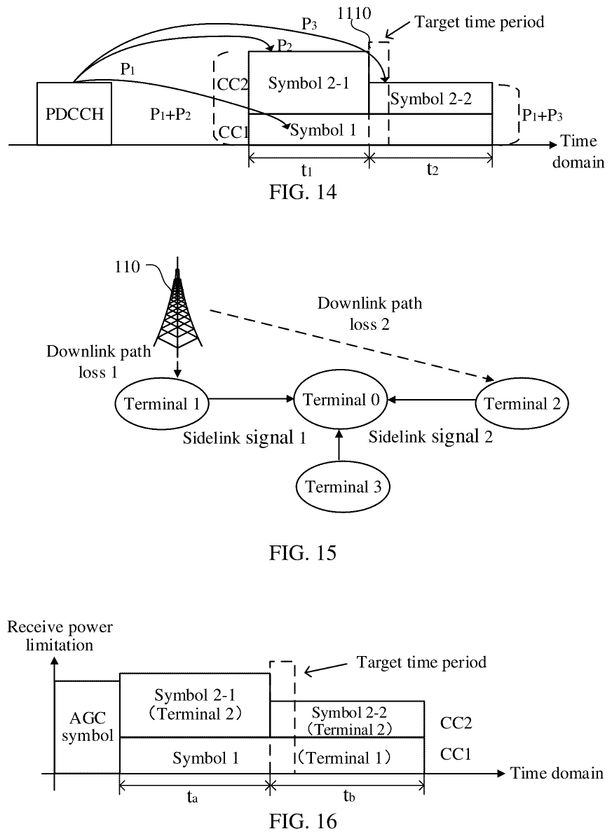

To facilitate understanding, the following section first introduces the scenario of signal reception on the first carrier and the second carrier with reference to FIG. 15. FIG. 15 is a schematic diagram of sidelink signal transmission between multiple terminal devices.

Currently, the transmit power of sidelink signal (e.g., the physical sidelink feedback channel (PSFCH)) is determined based on the downlink path loss (DL path loss) between the terminal device and the network device and the number of transmission resources (e.g., resource blocks (RBs)) used for the transmission of sidelink signals. Under an assumption where Terminal 1 transmits sidelink signal 1 to Terminal 0 on Symbol 1 corresponding to CC1, Terminal 2 transmits sidelink signal 2 to terminal 0 on Symbol 2-1 corresponding to CC2, and the distance between Terminal 1 and Terminal 0 is equal to the distance between Terminal 2 and Terminal 0, as shown in FIG. 15, since the distance between Terminal 1 and network device 110 is less than the distance between Terminal 2 and network device 110, the downlink path loss 1 of Terminal 1 is less than the downlink path loss 2 of Terminal 2. Accordingly, the transmit power of Terminal 1 is also less than the transmit power of Terminal 2. Although the distance between Terminal 1 and Terminal 0 is equal to the distance between Terminal 2 and Terminal 0, because the transmit power for Terminal 2 to transmit sidelink signal 2 is greater than the transmit power for Terminal 1 to transmit sidelink signal 1, the receive power for Terminal 0 to receive sidelink signal 2 is greater than the receive power for receiving sidelink signal 1.

The following continues to describe the sidelink signal transmission in the plurality of second time domain units in the above scenario. There are two cases based on whether the signals transmitted in the plurality of second time domain units come from the same transmitting terminal, which will be introduced below by using Scenario 2-1 and Scenario 2-2, respectively. Scenario 2-1 focuses on the receive power adjustment scheme in the case where the sidelink signals transmitted in the plurality of second time domain units come from the same transmitting terminal. Scenario 2-2 focuses on the transmit power adjustment scheme in the case where the sidelink signals transmitted in the plurality of second time domain units come from different transmitting terminals.

In Scenario 2-1, if sidelink signals transmitted in the plurality of second time domain units come from the same transmitting terminal, the adjustment of the receive power for signals within the target time period is performed based on the AGC adjustment result (also referred to as “AGC result”) associated with the first time domain unit. That is to say, if the plurality of carriers are used for transmitting signals, and the signals transmitted in the plurality of second time domain units are from the same transmitter, then the adjustment of the receive power for signals within the target time period is performed based on the AGC adjustment result associated with the first time domain unit. In an example where a first time domain unit is a symbol, the AGC adjustment result associated with the first time domain unit may be obtained at the time domain start position (e.g., AGC symbol) of the time slot where the first time domain unit is located.

To facilitate understanding, the following takes the receive power limitation variation manner shown in FIG. 6 as an example and introduces the schemes for adjusting the receive power in the embodiments of the present application with reference to FIG. 16. As shown in FIG. 16, time slot 1 is used for sidelink signal transmission, and time slot 1 includes an AGC symbol, Symbol 1 corresponding to CC1, Symbol 2-1 and Symbol 2-2 corresponding to CC2. Symbol 1, Symbol 2-1, and Symbol 2-2 are used for receiving sidelink signals. Before receiving a sidelink signal, Terminal 0 performs AGC power adjustment within the AGC symbol to ensure that the amplification gain of the receiver link meets requirements. Typically, Terminal 0 measures the signal strength of sidelink signals in the AGC symbol and sets the AGC amplification gain based on the signal strength. The AGC adjustment result determined within the AGC symbol in time slot 1 is the AGC adjustment result associated with Symbol 1.

As described above, the transmit power of a sidelink signal is associated with the number of transmission resources occupied by the sidelink signal. The transmission resources may include one or more of time domain resources, frequency domain resources, and spatial domain resources. Therefore, in some scenarios, the adjustment of the receive power of a signal within the target time period may be determined based on the difference in the quantity of the transmission resources occupied by the signals transmitted in the plurality of second time domain units.

In an exemplary communication scenario shown in FIG. 15, referring again to FIG. 16, in a case where the location of Terminal 2 does not change significantly (e.g., Terminal 2 is not in high-speed motion), the transmit power of sidelink signals transmitted by Terminal 2 on Symbol 2-1 and Symbol 2-2 may be considered as being affected only by the number of RBs occupied by the side signals. In this case, the variation in the transmit power of the sidelink signals transmitted by the Terminal 2 on Symbol 2-1 and Symbol 2-2 may be predictable. For example, Terminal 0 may first determine the difference in the number of RBs occupied by the sidelink signals transmitted by Terminal 2 on Symbol 2-1 and Symbol 2-2. Subsequently, based on the difference in the number of RBs, Terminal 0 can derive a receive power difference between the receive power limitation on Symbol 2-1 and the receive power limitation on Symbol 2-2. Finally, Terminal 0 can perform AGC adjustment during the target time period based on the receive power difference.

It should be noted that, during the adjustment of the receive power within the target time period, the measurement results on AGC symbols employed in the conventional scheme may be used for gain adjustment. For example, the receiving terminal can adjust the AGC gain within the target time period based on the aforementioned receive power difference. Therefore, during the adjustment of the receive power within the target time period, the receiving terminal may no longer measure the received signal power strength for the adjustment of its AGC gain. Instead, the receiving terminal can directly perform the adjustment based on the signal measurement results on the AGC symbols and the AGC adjustment results for the AGC symbols. Since signal measurement is not required during the target time period, this helps to shorten the time needed for AGC gain adjustment during the target time period. Certainly, in the embodiment of the present application, the receiving terminal may choose to re-measure the received signal power strength within the target time period and adjust its AGC gain based on the signal strength, which is not limited in the embodiments of the present application.

In Scenario 2-2, if the sidelink signals transmitted in the plurality of second time domain units come from different transmitting terminals, in this scenario, since the positions of the multiple transmitting terminals are difficult to predict, the transmit power limitation for the signals in the first time domain unit and the plurality of second time domain units, as well as the receive power limitation, cannot be known in advance, which makes it impossible to adjust the receive power within the target time period for receiving the sidelink signals transmitted in the next second time domain unit.

In an exemplary scenario shown in FIG. 15, the transmitting terminals include Terminal 1, Terminal 2 and Terminal 3. Terminal 1 occupies Symbol 1 on CC1 to transmit sidelink signal 1, Terminal 2 occupies Symbol 2-1 on CC2 to transmit sidelink signal 2, and Terminal 3 occupies Symbol 2-2 on CC2 to transmit sidelink signal 3. In this scenario, since the locations of Terminal 2 and Terminal 3 are difficult to predict, the transmit power limitation for Terminal 1 on Symbol 1, the transmit power limitation for Terminal 2 on Symbol 2-1, and the receive power limitation for the receiving terminal (Terminal 0) cannot be known in advance. As a result, it is impossible to adjust the receive power within the target time period for receiving the sidelink signal transmitted on Symbol 2-2.

Therefore, to address the above problems, the embodiments of the present application proposes a power adjustment solution. For ease of description, two adjacent time domain units in the time domain among the plurality of second time domain units are referred to as a fifth time domain unit and a sixth time domain unit, and the sixth time domain unit is earlier than the fifth time domain unit. Correspondingly, in the embodiments of the present application, during the target time period, the transmit power of a signal transmitted in the fifth time domain unit may be adjusted based on the transmit power limitation for a signal transmitted in the sixth time domain unit, so that the receive power of the sidelink signal transmitted in the fifth time domain unit is similar to that of the sidelink signal transmitted in the sixth unit, which helps to improve the performance of the signal transmitted in the fifth time domain unit. Since the receive power of the signal transmitted in the sixth unit may be adjusted according to the conventional AGC process, the transmit power limitation for the signal transmitted in the sixth time domain unit matches the receive power limitation for the receiving terminal. Accordingly, the transmit power limitation for the signal transmitted in the fifth time domain unit can be adjusted according to the transmit power limitation for the signal transmitted in the sixth time domain unit, the transmit power of the signal transmitted in the fifth time domain unit will also match the receive power of the receiving terminal.

In some implementations, a terminal device (i.e., the receiving terminal of the sidelink signal) may transmit a first transmit power limitation to transmitting Terminal 2 within the target time period. The first transmit power limitation is the transmit power limitation for transmitting Terminal 1 to transmit signals within the sixth time domain unit. Accordingly, transmitting Terminal 2 may determine the transmit power for transmitting sidelink signals in the fifth time domain unit based on the first transmit power limitation and the path loss between transmitting Terminal 2 and receiving terminal.

In some implementations, transmitting Terminal 2 can determine the transmit power limitation used for transmitting sidelink signals in the fifth time domain unit (also referred to as the “transmit power limitation associated with the fifth time domain unit”), based on the first transmit power limitation and the path loss between transmitting Terminal 2 and receiving terminal. Based on the transmit power limitation associated with the fifth time domain unit, transmitting Terminal 2 can determine the transmit power used for transmitting signals in the fifth time domain unit (also referred to as the “transmit power associated with the fifth time domain unit”). Then, based on the transmit power associated with the fifth time domain unit, transmitting Terminal 2 can transmit signals in the fifth time domain unit. That is to say, the transmit power of signals in the fifth time domain unit is less than or equal to the transmit power limitation associated with the fifth time domain unit. Certainly, in the embodiments of the present application, the transmit power used for transmitting sidelink signals in the fifth time domain unit may also be directly determined based on the first transmit power limitation and the path loss between transmitting Terminal 2 and receiving terminal.

In some implementations, the first transmit power may be transmitted through the sidelink information. For example, receiving terminal may transmit the sidelink information carrying the first transmit power in a broadcast manner, and correspondingly, transmitting Terminal 2 may obtain the sidelink information carrying the first transmit power. Certainly, the sidelink information carrying the first transmit power may also be transmitted in other ways.

In some implementations, the transmit power limitation P_{power limit} associated with the fifth time domain unit may be determined by the formula: P_{power limit}=P_{transmitting Terminal 1}+PL₁, where P_{transmitting Terminal 1} denotes the transmit power limitation for sidelink signals transmitted by transmitting Terminal 1 in the sixth time domain unit, and PL₁ denotes the power adjustment value determined based on the path loss between transmitting Terminal 2 and receiving terminal.

It should be noted that, if the path loss between transmitting Terminal 2 and receiving terminal is less than the path loss between transmitting Terminal 1 and receiving terminal, the power adjustment value in the above formula may be a negative value. If the path loss between transmitting Terminal 2 and receiving terminal is greater than the path loss between transmitting Terminal 1 and receiving terminal, then the power adjustment value in the above formula may be a positive value.

In addition, in the embodiments of the present application, in the case where the path loss between transmitting Terminal 2 and receiving terminal is less than the path loss between transmitting Terminal 1 and receiving terminal, it can be considered that the distance between transmitting Terminal 2 and receiving terminal is less than the distance between transmitting Terminal 1 and receiving terminal. In the case where the path loss between transmitting Terminal 2 and receiving terminal is greater than the path loss between transmitting Terminal 1 and receiving terminal, it can be considered that the distance between transmitting Terminal 2 and receiving terminal is greater than the distance between transmitting Terminal 1 and receiving terminal.

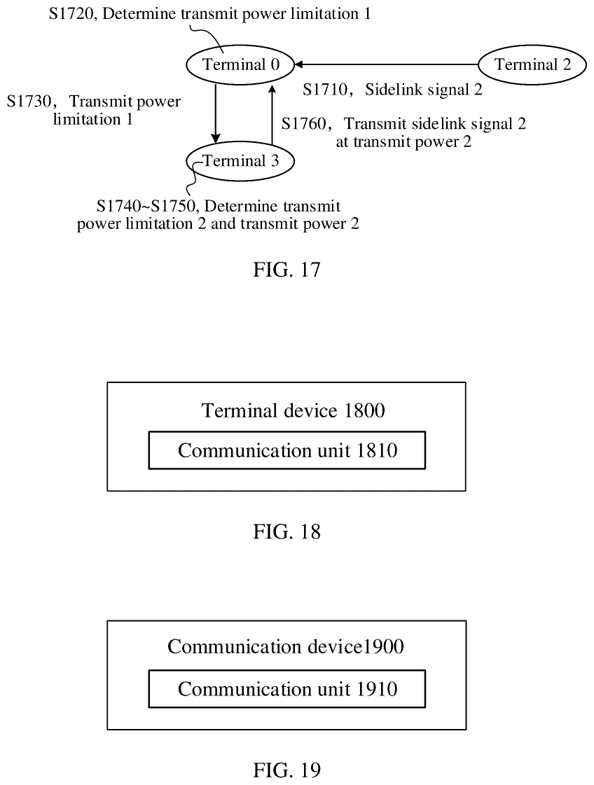

To facilitate understanding, with reference to FIG. 17, a method for adjusting transmit power in the embodiments of the present application will be described below by using the variation in transmit power limitation shown in FIG. 11 as an example. FIG. 17 is a schematic diagram of the method for adjusting transmit power in the embodiments of the present application. The method shown in FIG. 17 includes steps S1710 to S1760.

Referring to FIG. 11, it is assumed that the fifth time domain unit is Symbol 2-2 and the sixth time domain unit is Symbol 2-1. Terminal 0 receives sidelink signal 2 transmitted by Terminal 2 on Symbol 2-1, and Terminal 0 receives sidelink signal 3 transmitted by Terminal 3 on Symbol 2-2.

As shown in FIG. 17, in step S1710, Terminal 2 transmits sidelink signal 2 to Terminal 0 on Symbol 2-1.

In step S1720, in response to receiving sidelink signal 2, Terminal 0 determines transmit power limitation 1 for sidelink signal 2 transmitted on Symbol 2-1.

In step S1730, Terminal 0 indicates transmit power limitation 1 to Terminal 3.

In step S1740, Terminal 3 determines transmit power limitation 2 based on transmit power limitation 1 and a power adjustment value.

For example, transmit power limitation 2 may be determined through the formula: P_{power limit 2}=P_{power limit 1}+PL₁, where P_{power limit 2} denotes transmit power limitation 2, P_{power limit 1} denotes transmit power limitation 1, and PL₁ denotes the power adjustment value determined based on the path loss between Terminal 3 and Terminal 0.

In step S1750, Terminal 3 determines transmit power 2 of sidelink signal 2 transmitted on Symbol 2-2 based on transmit power limitation 2.

In step S1760, Terminal 3 transmits sidelink signal 2 on Symbol 2-2 at transmit power 2.

The method embodiments of the present application are described above with reference to FIGS. 1 to 17. The device embodiments of the present application will be described below in detail with reference to FIGS. 18 to 20. It should be understood that the description of the method embodiments corresponds to the description of the device embodiments. Therefore, for parts not described in detail, reference may be made to the foregoing method embodiments.

FIG. 18 is a schematic diagram of a terminal device according to the embodiments of the present application. The terminal device 1800 shown in FIG. 18 includes a communication unit 1810.

The communication unit 1810 is configured to transmit or receive a signal through a plurality of carriers, where time domain units corresponding to a portion or all of the plurality of carriers have different durations, and the time domain units corresponding to the portion or all of the plurality of carriers overlap in the time domain. The time domain units corresponding to the plurality of carriers include a target time period, and the target time period is used for adjusting target power of the signal.

In a possible implementation, the plurality of carriers include a first carrier and a second carrier, the first carrier corresponds to a first time domain unit, and the second carrier corresponds to a second time domain unit. A portion of or entire duration of the first time domain unit is overlapped by the durations of the plurality of second time domain units, and the duration of the first time domain unit is greater than the duration of the second time domain unit.

In a possible implementation, the time domain location of the target time period is determined based on a first time domain position, and the first time domain position includes a time domain end position of a third time domain unit and/or a time domain start position of a fourth time domain unit. The third time domain unit and the fourth time domain unit are two time domain units adjacent in time domain among the plurality of second time domain units, and the third time domain unit is earlier than the fourth time domain unit.

In a possible implementation, the time domain location of the target time period satisfies one of that: a time domain start position of the target time period is the first time domain position; a time domain end position of the target time period is the first time domain position; a time domain center position of the target time period is the first time domain position.

In a possible implementation, the time domain location of the target time period is determined based on one or more of: predefined information, a preset rule, configuration information, information indicating a time domain location of the target time period suggested by the terminal device.

In a possible implementation, if the time domain location of the target time period is determined based on the preset rule, the preset rule is associated with one or more of: a priority of the service transmitted in the second time domain unit; or target power of a signal transmitted in the second time domain unit.

In a possible implementation, the duration of the target time period is determined based on one or more of: a sub-carrier spacing of the first carrier, a sub-carrier spacing of the second carrier, or a candidate duration of the target time period supported by the terminal device.

In a possible implementation, a duration of the target time period is determined based on pre-configuration information and/or terminal device capability information.

In a possible implementation, if the duration of the target time period is determined based on the terminal device capability information of the terminal device, the terminal device capability information carries a candidate duration of the target time period supported by the terminal device.

In a possible implementation, the capability information of the terminal device is used to indicate that the terminal device supports a first feature, and the first feature includes adjusting the target power within the target time period.

In a possible implementation, the configuration and/or activation of the target time period is determined based on a first condition, which includes one or more of that: signals transmitted in two second time domain units adjacent in the time domain have different target power; a sub-carrier spacing of the first carrier is different from a sub-carrier spacing of the second carrier; or the duration of the first time domain unit is different from the duration of the second time domain unit.

In a possible implementation, if the plurality of carriers are used for transmitting the signal and the target power is transmit power, then a variation in transmit power of signals transmitted in the plurality of second time domain units is determined based on the transmit power scheduled by a network device; if the plurality of carriers are used for receiving the signal and the target power is receive power, then a variation in receive power of signals transmitted in the plurality of second time domain units is determined based on an amount of resources used for transmitting signals.

In a possible implementation, if a variation in the receive power of the signals transmitted in the plurality of second time domain units is determined based on the amount of resources used for transmitting signals, the signals transmitted in the second time domain units are from the same transmitter.

In a possible implementation, if the plurality of carriers are used for transmitting the signal, the target time period is used for adjusting transmit power of the signal; if the plurality of carriers are used for receiving the signal, the target time period is used for adjusting receive power of the signal; or if the plurality of carriers are used for receiving the signal, the target time period is used for adjusting transmit power of the signal.

In a possible implementation, if the plurality of carriers are used for transmitting the signal, and signals transmitted in the plurality of second time domain units are from the same transmitter, then the adjustment of the receive power of the signal within the target time period is performed based on an AGC result of the first time domain unit.

In a possible implementation, if the plurality of carriers are used for receiving the signal, and signals transmitted in the plurality of second time domain units are from different transmitters, then the target time period is used for adjusting transmit power of a signal transmitted in the fifth time domain unit, and the transmit power of the signal transmitted in the fifth time domain unit is determined based on transmit power of a signal in a sixth time domain unit. The fifth time domain unit and the sixth time domain unit are two time domain units adjacent in the time domain among the plurality of second time domain units, and the sixth time domain unit is earlier than the fifth time domain unit.

FIG. 19 is a schematic diagram of a communication device according to the embodiments of the present application. The communication device 1900 shown in FIG. 19 includes a communication unit 1910.

The communication unit 1910 is configured to receive or transmit a signal through a plurality of carriers, where the time domain units corresponding to a portion or all of the plurality of carriers have different durations, and the time domain units corresponding to the portion or all of the plurality of carriers overlap in the time domain. Time domain units corresponding to the plurality of carriers include a target time period, and the target time period is used for adjusting target power of the signal.

In a possible implementation, the plurality of carriers include a first carrier and a second carrier, the first carrier corresponds to a first time domain unit, and the second carrier corresponds to second time domain units. A portion of or the entire duration of the first time domain unit is overlapped by durations of a plurality of second time domain units, and the duration of the first time domain unit is greater than a duration of a second time domain unit.

In a possible implementation, the time domain location of the target time period is determined based on the first time domain position, and the first time domain position includes a time domain end position of a third time domain unit and/or a time domain start position of a fourth time domain unit. The third time domain unit and the fourth time domain unit are two time domain units adjacent in time domain among the plurality of second time domain units, and the third time domain unit is earlier than the fourth time domain unit.

In a possible implementation, the time domain location of the target time period satisfies one of that: a time domain start position of the target time period is the first time domain position; a time domain end position of the target time period is the first time domain position; or a time domain center position of the target time period is the first time domain position.

In a possible implementation, the time domain location of the target time period is determined based on one or more of: predefined information, a preset rule, configuration information, information indicating a time domain location of the target time period suggested by the terminal device.

In a possible implementation, if the time domain location of the target time period is determined based on the preset rule, the preset rule is associated with one or more of: a priority of a service transmitted in a second time domain unit; or target power of a signal transmitted in a second time domain unit.

In a possible implementation, a duration of the target time period is determined based on one or more of: a sub-carrier spacing of the first carrier, a sub-carrier spacing of the second carrier, or a candidate duration of the target time period supported by the terminal device.

In a possible implementation, a duration of the target time period is determined based on pre-configuration information and/or terminal device capability information.

In a possible implementation, if the duration of the target time period is determined based on the terminal device capability information of the terminal device, the terminal device capability information carries a candidate duration of a target time period supported by the terminal device.

In a possible implementation, the capability information of the terminal device is used to indicate that the terminal device supports a first feature, and the first feature includes adjusting the target power within the target time period.

In a possible implementation, the configuration and/or activation of the target time period is determined based on a first condition, which includes one or more of the following: signals transmitted in two second time domain units adjacent in the time domain have different target power; a sub-carrier spacing of the first carrier is different from the sub-carrier spacing of the second carrier; the duration of the first time domain unit is different from the duration of the second time domain unit.

In a possible implementation, if the plurality of carriers are used for transmitting the signal and the target power is transmit power, then a variation in transmit power of signals transmitted in the plurality of second time domain units is determined based on a transmit power scheduled by the network device; or if the plurality of carriers are used for receiving the signal and the target power is receive power, then a variation in receive power of signals transmitted in the plurality of second time domain units is determined based on an amount of resources used for transmitting signals.

In a possible implementation, if the in the receive power of signals transmitted in the plurality of second time domain units is determined based on the amount of resources used for transmit signals, the signals transmitted in the second time domain units are from the same transmitter.

In a possible implementation, if the plurality of carriers are used for transmitting the signal, the target time period is used for adjusting transmit power of the signal; if the plurality of carriers are used for receiving the signal, the target time period is used for adjusting receive power of the signal; or if the plurality of carriers are used for receiving the signal, the target time period is used for adjusting transmit power of the signal.

In a possible implementation, if the plurality of carriers are used for transmitting the signal, and signals transmitted in the plurality of second time domain units are from the same transmitter, then adjustment of the receive power of the signal within the target time period is performed based on an AGC result of the first time domain unit.

In a possible implementation, if the plurality of carriers are used for receiving the signal, and signals transmitted in the plurality of second time domain units are from different transmitters, then the target time period is used for adjusting transmit power of a signal transmitted in a fifth time domain unit, and transmit power of the signal transmitted in the fifth time domain unit is determined based on transmit power of a signal in a sixth time domain unit. The fifth time domain unit and the sixth time domain unit are two time domain units adjacent in the time domain among the plurality of second time domain units, and the sixth time domain unit is earlier than the fifth time domain unit.

In a possible implementation, the above-mentioned communication device (also referred to as “target device”) may be a network device or another terminal device other than the terminal device (terminal device 1800) introduced above.

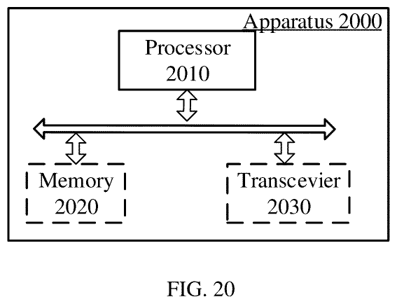

In an optional embodiment, the communication unit 1810 may be a transceiver 2030. The terminal device 1800 may further include a processor 2010 and a memory 2020, as shown in FIG. 20.

In an optional embodiment, the communication unit 1910 may be a transceiver 2030. The communication device 1900 may further include a transceiver 2030 and a memory 2020, as shown in FIG. 20.

FIG. 20 is a schematic structural diagram of a communication device according to the embodiments of the present application. The dashed lines in FIG. 20 indicate that the unit or module is optional. The apparatus 2000 may be used to implement the methods described in the foregoing method embodiments. The apparatus 2000 may be a chip, a terminal device, or a network device.

The apparatus 2000 may include one or more processors 2010. The processor 2010 may support the apparatus 2000 in implementing the methods described in the foregoing method embodiments. The processor 2010 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or other programmable logic device, a discrete gate or a transistor logic device, a discrete hardware component, etc. The general-purpose purpose processor may be a microprocessor, or the processor may also be any conventional processor.

The apparatus 2000 may further include one or more memories 2020. A program is stored on the memory 2020, and the program may be executed by the processor 2010 to cause the processor 2010 to execute the methods described in the foregoing method embodiments. The memory 2020 may be independent of the processor 2010 or integrated within the processor 2010.

The apparatus 2000 may further include a transceiver 2030. The processor 2010 may communicate with other devices or chips through the transceiver 2030. For example, the processor 2010 may transmit and receive data with other devices or chips through the transceiver 2030.

The embodiments of the present application further provide a non-transitory computer-readable storage medium, which is configured to store a program. The non-transitory computer-readable storage medium may be applied to a terminal or network device provided in the embodiments of the present application, and the program causes a computer to execute the methods performed by the terminal or network device in various embodiments of the present application.

The embodiments of the present application further provide a computer program product. The computer program product includes a program. The computer program product may be applied to a terminal or network device provided in the embodiments of the present application, and the program causes a computer to execute the methods performed by the terminal or network device in various embodiments of the present application.

The embodiments of the present application further provide a computer program. The computer program may be applied to a terminal or network device provided in the embodiments of the present application, and the computer program causes a computer to execute the methods performed by the terminal or network device in various embodiments of the present application.

It is to be understood that the terms “system” and “network” may be used interchangeably in the present application. In addition, terms used in the present application are only used to explain embodiments of the present application and are not intended to limit the present application. The terms “first”, “second”, “third”, “fourth” or the like in the specification, claims and the drawings are used to distinguish different objects and are not used to describe a specified sequence. In addition, the terms “include”, “comprise” and “have” and any variations thereof are intended to cover non-exclusive inclusion.

In the embodiments of the present application, “indicate” mentioned in the embodiments of the present application may mean a direct indication or an indirect indication, or represent that there is an association relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the embodiments of the present application, “B corresponding to A” means that B is associated with A, and B may be determined based on A. However, it is also to be understood that determining B based on A does not mean that B is determined based on A alone; and B may also be determined based on A and/or other information.

In the embodiments of the present application, the term “correspond” may mean that there is a direct correspondence or indirect correspondence between the two, or it may mean that there is an associated relationship between the two, or it may mean a relationship of indicating and being indicated, configuring and being configured, or the like.

In the embodiment of the present application, “predefined” or “preconfigured” may be achieved by pre-storing corresponding codes, forms or other means used for indicating relevant information in devices (e.g., including a terminal device and network device), and the present application is not limited to the implementation thereof. For example, predefined may refer to what is defined in a protocol.

In the embodiments of the present application, the “protocol” may refer to a standard protocol in the field of communication, and may include, for example, LTE protocol, NR protocol, or related protocols applied in future communication systems, which are not limited in the present application.

In the embodiments of the present application, the term “and/or” is only an association relationship to describe associated objects, meaning that there may be three relationships between associated objects, for example, “A and/or B” may represent: A exists alone, both A and B exist, and B exists alone. In addition, a character “/” herein generally means that related objects before and after this character are in an “or” relationship.

In various embodiments of the present application, the magnitude of the serial numbers of above processes does not mean the order of execution. The order of execution of each process should be determined by its function and internal logic, and should not constitute any limitation on the implementation process of the embodiments of the present application.

In the several embodiments provided in the present application, it is to be understood that the disclosed systems, devices and methods may be implemented in other ways. For example, the device embodiments described above are merely illustrative. For example, the division of the units is merely a logical function division. There may be other division ways in the actual implementation. For example, multiple units or components may be combined or integrated into another system, or some features may be ignored or not implemented. Another point is that the mutual coupling or direct coupling or communication connection illustrated or discussed may be indirect coupling or communication connection through some interface, device or units, and may be electrical, mechanical or other forms.

The units described as separation parts may or may not be physically separated, and the component displayed as a unit may be or may not be a physical unit, that is, it may be located at one place, or it may be distributed to multiple network units. Some or all of the units may be selected according to actual requirements to achieve the purpose of the schemes of the embodiments.

In addition, various functional units in various embodiments of the present application may be integrated into one processing unit, various units may exist physically alone, or two or more units may be integrated into one unit.

In the above embodiments, all or part of them may be implemented by software, hardware, firmware or any combinations thereof. When implemented by the software, all or part of them may be implemented in the form of a computer program product. The computer program product includes one or more computer instructions. When the computer program instructions are loaded and executed on a computer, the processes or functions described in the embodiments of the present application are generated in whole or in part. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, a computer, a server or a data center to another website, computer, server, or data center via wired (e.g., a coaxial cable, optical fiber, digital subscriber line (DSL)) or wireless (e.g., infrared, wireless, microwave) means. The computer-readable storage medium may be any available medium that may be read by the computer or a data storage device such as a server or a data center that includes one or more available media. The available media may be magnetic media (e.g., a floppy disk, a hard disk or a magnetic tape), optical media (e.g., a digital video disc (DVD)), or semiconductor media (e.g., a solid state disk (SSD)).

The foregoing descriptions are merely exemplary implementations of the present application, but the protection scope of the present application is not limited thereto. Variations or replacements that any person skilled in the art could readily conceive of within the technical scope disclosed in the present application shall fall within the protection scope of the present application. Therefore, the protection scope of the present application shall be subject to the protection scope of the claims.

What is claimed is:

1. A terminal device, comprising:
a communication unit, configured to transmit or receive a signal through a plurality of carriers, wherein time domain units corresponding to a portion or all of the plurality of carriers have different durations, and the time domain units corresponding to the portion or all of the plurality of carriers overlap in time domain;
wherein time domain units corresponding to the plurality of carriers include a target time period, and the target time period is used for adjusting target power of the signal.

2. The terminal device according to claim 1, wherein the plurality of carriers comprise a first carrier and a second carrier, the first carrier corresponds to a first time domain unit, and the second carrier corresponds to second time domain units; wherein a portion of or entire duration of the first time domain unit is overlapped by durations of a plurality of second time domain units, and the duration of the first time domain unit is greater than the duration of a second time domain unit.

3. The terminal device according to claim 2, wherein a time domain location of the target time period is determined based on a first time domain position, and the first time domain position comprises a time domain end position of a third time domain unit and/or a time domain start position of a fourth time domain unit;
wherein the third time domain unit and the fourth time domain unit are two time domain units adjacent in time domain among the plurality of second time domain units, and the third time domain unit is earlier than the fourth time domain unit.

4. The terminal device according to claim 3, wherein the time domain location of the target time period satisfies one of:
a time domain start position of the target time period is the first time domain position;
a time domain end position of the target time period is the first time domain position; or
a time domain center position of the target time period is the first time domain position.

5. The terminal device according to claim 2, wherein a time domain location of the target time period is determined based on one or more of the following information: predefined information, a preset rule, configuration information, information indicating a time domain location of the target time period suggested by the terminal device.

6. The terminal device according to claim 5, wherein if the time domain location of the target time period is determined based on the preset rule, and the preset rule is associated with one or more of:
a priority of a service transmitted in a second time domain unit; or
target power of a signal transmitted in a second time domain unit.

7. The terminal device according to claim 2, wherein a duration of the target time period is determined based on one or more of:
a sub-carrier spacing of the first carrier;
a sub-carrier spacing of the second carrier; or
a candidate duration of the target time period supported by the terminal device.

8. The terminal device according to claim 2, wherein a duration of the target time period is determined based on pre-configuration information and/or terminal device capability information.

9. The terminal device according to claim 8, wherein if the duration of the target time period is determined based on the terminal device capability information of the terminal device, the terminal device capability information carries a candidate duration of a target time period supported by the terminal device.

10. The terminal device according to claim 8, wherein the capability information of the terminal device is used to indicate that the terminal device supports a first feature, and the first feature comprises adjusting the target power within the target time period.

11. The terminal device according to claim 2, wherein configuration and/or activation of the target time period is determined based on a first condition, and the first condition comprises one or more of the following:
signals transmitted in two second time domain units adjacent in time domain have different target power;
a sub-carrier spacing of the first carrier is different from a sub-carrier spacing of the second carrier; or
the duration of the first time domain unit is different from the duration of the second time domain unit.

12. The terminal device according to claim 2, wherein if the plurality of carriers are used for transmitting the signal and the target power is transmit power, then a variation in transmit power of signals transmitted in the plurality of second time domain units is determined based on transmit power scheduled by a network device; or
if the plurality of carriers are used for receiving the signal and the target power is receive power, then a variation in receive power of signals transmitted in the plurality of second time domain units is determined based on an amount of resources used for transmitting signals.

13. The terminal device according to claim 12, wherein if the variation in the receive power of the signals transmitted in the plurality of second time domain units is determined based on the amount of resources used for transmitting signals, the signals transmitted in the second time domain units are from the same transmitter.

14. The terminal device according to claim 2, wherein if the plurality of carriers are used for transmitting the signal, the target time period is used for adjusting transmit power of the signal;
if the plurality of carriers are used for receiving the signal, the target time period is used for adjusting receive power of the signal; or
if the plurality of carriers are used for receiving the signal, the target time period is used for adjusting transmit power of the signal.

15. The terminal device according to claim 14, wherein if the plurality of carriers are used for transmitting the signal, and signals transmitted in the plurality of second time domain units are from the same transmitter, then adjustment of the receive power of the signal within the target time period is performed based on an AGC result of the first time domain unit.

16. The terminal device according to claim 14, wherein if the plurality of carriers are used for receiving the signal, and signals transmitted in the plurality of second time domain units are from different transmitters, then the target time period is used for adjusting transmit power of a signal transmitted in a fifth time domain unit, and the transmit power of the signal transmitted in the fifth time domain unit is determined based on transmit power of a signal transmitted in a sixth time domain unit;
wherein the fifth time domain unit and the sixth time domain unit are two time domain units adjacent in time domain among the plurality of second time domain units, and the sixth time domain unit is earlier than the fifth time domain unit.

17. A communication device, comprising:
a communication unit, configured to receive or transmit a signal through a plurality of carriers, wherein time domain units corresponding to a portion or all of the plurality of carriers have different durations, and the time domain units corresponding to the portion or all of the plurality of carriers overlap in time domain;
wherein time domain units corresponding to the plurality of carriers include a target time period, and the target time period is used for adjusting the target power of the signal.

18. The communication device according to claim 17, wherein the plurality of carriers comprise a first carrier and a second carrier, the first carrier corresponds to a first time domain unit, and the second carrier corresponds to second time domain units; wherein a portion of or entire duration of the first time domain unit is overlapped by durations of a plurality of second time domain units, and the duration of the first time domain unit is greater than the duration of a second time domain unit.

19. The communication device according to claim 18, wherein a time domain location of the target time period is determined based on a first time domain position, the first time domain position comprises a time domain end position of a third time domain unit and/or a time domain start position of a fourth time domain unit;
wherein the third time domain unit and the fourth time domain unit are two time domain units adjacent in time domain among the plurality of second time domain units, and the third time domain unit is earlier than the fourth time domain unit.

20. The communication device according to claim 19, wherein the time domain location of the target time period satisfies one of:
a time domain start position of the target time period is the first time domain position;
a time domain end position of the target time period is the first time domain position; or
a time domain center position of the target time period is the first time domain position.
